(19) United States
(12) Patent Application Publication
(10) Pub. No.: US 2015/0065252 A1
(43) Pub. Date: Mar. 5, 2015

(54) SERVER AND GAME APPLICATION PROGRAM FOR PROVIDING ONLINE GAMES

(71) Applicant: DeNA Co., Ltd., Tokyo (JP)

(72) Inventor: Ryuji IKEDA, Tokyo (JP)

(73) Assignee: DeNA Co., Ltd., Tokyo (JP)

(21) Appl. No.: 14/109,617

(22) Filed: Dec. 17, 2013

(30) Foreign Application Priority Data
Aug. 30, 2013 (JP) 2013-178794

(51) Int. Cl. A63F 13/30

(52) U.S. Cl. CPC A63F 13/12
USPC 463/42

(57) ABSTRACT

A server device according to an embodiment of the present invention provides game services to a client terminal communicatively connected to the server device. The server device includes one or more processors configured to execute a particular program. In an embodiment, the particular program includes: a progress management module configured to manage the progress of the first game based on the first game progress data related to the progress of the first game provided by the client terminal executing the first game application program; and a data providing module configured to provide the client terminal with the first object generation data for generating the first object in accordance with the progress of the first game. The server device can grant a reward to a player when receiving from the client terminal a first game switch notification indicating that the switch process to the second game application program has been started.

### TECHNICAL FIELD

### Cross-Reference to Related Applications

This application is based on and claims the benefit of priority from Japanese Patent Application Serial No. 2013-178794 (filed on Aug. 30, 2013), the contents of which are hereby incorporated by reference in their entirety.

The embodiments of the present invention relates to a server device and a game application program for providing online games.

### BACKGROUND

Conventionally, there are known server devices for providing online games to client terminals such as smart phones and cell phones via a communication network. Such server devices process game messages received from client terminals in accordance with a particular game logic and return the result of the processing to the client terminals. The server devices also provide various game data required for progress of the games to the client terminals.

The client terminals generate game screens through application programs or a browser based on the game data received from the server device and display the generated game screens. A player can interact with the games through the game screens (e.g., the player inputs instruction for operating a player character or select a menu).

The game screens of online games may include a link to a web page for providing other games so as to guide the player to the destination web page. Such a method of guiding a player to other games using a link is employed in many games such as “Kaito Royale” provided by the Applicant (see Non-patent Literature 1 below).

### RELEVANT REFERENCES

### List of Relevant Non-Patent Literature

Non-patent Literature 1: “Kaito Royale,” [Online], DeNA Co., Ltd., [Retrieved on Aug. 22, 2013], the Internet, <https://itunes.apple.com/jp/app/guai-daorowaiyaru/id464716052?mt=8>

### SUMMARY

Unfortunately, in the conventional method of guidance described above, links to other games are displayed at timings independent of the progress of the link-source game (the game displaying the links), for example, when a new game is released or an event occurs in another game. Therefore, the conventional method of guidance to other games may cause a player to deflect from the link-source game at an undesirable timing in view of the progress of the game. For example, a player may be guided to another game at an early timing before the player is devoted to the link-source game. The link-source game is already being played by the player with interest, while the link-destination game is uncertain whether it attracts the player; therefore, it is undesirable to deflect the player from the link-destination game carelessly.

Also, since the link-destination game progresses independently from the link-source game, a player hoping to play the link-source game again has to make an operation to access the web page of the link-source game or activate an application program for executing the link-source game again. Thus, once a player deflects from the link-source game, a troublesome operation is required to return to the link-source game.

To overcome this problem, the present invention has an object of improving the timing of guidance to other games in online games. Another object of the present invention is to enable a player guided to other games to return to the link-source game easily. The other objects of the present disclosure will be apparent with reference to the entire description in this specification.

A server device according to an embodiment of the present invention provides game services to a client terminal communicatively connected to the server device, and the server device comprises: one or more processors configured to execute a computer program. In an embodiment, the computer program comprises: a progress management module configured to manage progress of a first game based on first game progress data related to progress of the first game by a player, the first game progress data being provided by the client terminal executing a first game application program; a data providing module configured to provide the client terminal with first object generation data for generating first object, in accordance with progress of the first game; a reception module configured to receive a first game switch notification from the client terminal if the first object is selected in the first game to start a switch process to a second game application program on the client terminal; and a reward granting module configured to grant a first reward to the player in response to the first game switch notification.

A game application program according to an embodiment of the present invention causes a client terminal communicatively connected to a server device to execute a first game. In an embodiment, the game application program comprises: a progress data providing module configured to provide the server device with game progress data indicating progress of the first game; an object generation module configured to generate a first object based on first object generation data provided by the server device in accordance with progress of the first game indicated by the game progress data; an object presenting module configured to present the first object to a player of the first game; a game switch module configured to execute a switch process to another application program for causing the client terminal to execute a second game, in response to a selecting operation on the first object and a reward granting module configured to grant a reward to the player when the switch process is executed.

Various embodiments of the present invention improve the guidance timings to other games in online games.

### BRIEF DESCRIPTION OF THE DRAWINGS

FIG. 1 is a block diagram schematically illustrating a system including a server device and a game application program according to an embodiment of the present invention.

FIG. 2 is a block diagram schematically illustrating the functions of game server modules to be executed in a server device according to an embodiment of the present invention.

FIG. 3 is a block diagram schematically illustrating the functions of a game application program according to an embodiment of the present invention.

FIG. 4 is a diagram showing an example of a game screen according to an embodiment of the present invention.

FIG. 5 is a diagram showing an example of a game screen according to an embodiment of the present invention.

FIG. 6 is a diagram showing an example of a game screen according to an embodiment of the present invention.

FIG. 7 is a diagram showing an example of a game screen according to an embodiment of the present invention.

FIG. 8 is a flow diagram showing the flow of a process for switching a client terminal from a first game application program to a second application program.

### DESCRIPTION OF EXAMPLE EMBODIMENTS

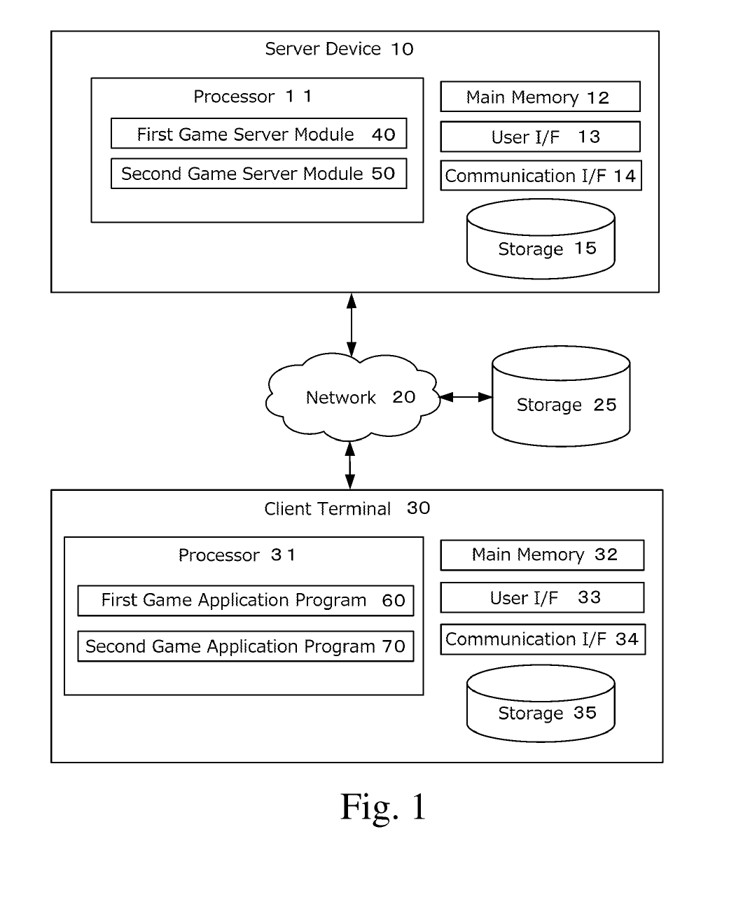

FIG. 1 is a block diagram schematically illustrating a system including a client terminal and a server device for providing game services to the client terminal in accordance with an embodiment of the present invention. The system shown in FIG. 1 may include the server device 10 and the client terminal 30. The server device 10 may be communicatively connected to the client terminal 30 via a network 20 such as the Internet and provide the client terminal 30 with online game services. For example, the server device 10 may process a game message (e.g., a message related to operations of a player character or a message that a quest has been started) received from the client terminal 30 in accordance with a predetermined game logic (or a program for implementing the game logic), and return a result of the process to the client terminal. The server device 10 may also provide various game data required for progress of the games to the client terminal 30. Although FIG. 1 shows only one client terminal 30, the server device 10 may be communicatively connected to a plurality of client terminals 30.

As shown, the server device 10 may include a processor 11, a main memory 12, a user I/F 13, a communication I/F 14, and a storage 15. These components may be electrically connected to each other via a bus not shown. The processor 11 may load an operating system and various programs for implementing the game logic into the main memory 12 from the storage 15, and may execute commands included in the loaded programs. The main memory 12 may be used to store a program to be executed by the processor 11, and may be formed of, for example, a dynamic random access memory (DRAM).

The user I/F 13 may include, for example, an information input device such as a keyboard or a mouse for accepting an input from an operator, and an information output device such as a liquid crystal display for outputting calculation results of the processor 11. The communication I/F 14 may be implemented as hardware, firmware, or communication software such as a transmission control protocol/Internet protocol (TCP/IP) driver or a point-to-point protocol (PPP) driver, or a combination thereof, and may be configured to be able to communicate with the client terminal 30 via the network 20.

The storage 15 may be formed of, for example, a magnetic disk drive and store various programs such as a game control program for implementing the game logic. The storage 15 may also store various data used in the game. The various data that may be stored in the storage 15 may also be stored on a database server communicatively connected to the server device 10 and physically separate from the server device 10.

In an embodiment, the server device 10 may be a web server for managing a web site including a plurality of hierarchical web pages. The client terminal 30 may fetch HTML data for rendering these web pages from the server device 10 and analyze the fetched HTML data to render a game screen on a display of the client terminal 30. A player may provide various inputs to the client terminal 30 via the game screen thereby to interact with a game provided by the server device 10 (e.g., the player may operate a player character with instructions or select a menu). A game provided through such a web page is sometimes called a browser game. The storage 15 may store the HTML data for rendering the web page. The HTML data may be composed of HTML code written in a markup language such as HTML. The HTML code may be associated with various images. Additionally, the HTML data may include programs written in script languages such as ActionScript™ and JavaScript™

The storage 15 may store game application programs to be executed on execution environments, such as an OS or middleware, of the client terminal 30. The game application programs may include, on execution on the client terminal 30, instruction sets for processing game data provided by the server device 10 and various data such as image data referred to when the instruction sets are executed. The game application programs may be created in, for example, object oriented languages such as Objective-C™ and Java™. The created game application programs may be stored on the storage 15. The game application programs may also be stored on an external storage 25 outside the server device 10 or another storage not shown.

In response to a delivery request from the client terminal 30, the game application programs stored on a storage such as the storage 15 or the external storage 25 may be delivered to the client terminal 30. The delivered game application programs may be received by the client terminal 30 via a communication I/F 34 under the control by the processor 31. The received game application programs may be stored on, e.g., the storage 35. The application software may be launched in accordance with the player's operation on the client device 30 and may be executed on a platform, such as an OS or middleware, implemented on the client device 30.

The game application programs may send various game messages to the server device 10 while being executed on the client terminal 30. The server device 10 may process the game messages from the client terminal 30 in accordance with a predetermined game logic to control the progress of the game. For example, the server device 10 may receive a quest management message from the client terminal 30 indicating that a particular quest on a map has been completed, and provide quest information related to another quest.

The game application programs executed on the client terminal 30 may receive from the server device 10 a result of the process of the game messages. The game application programs may generate a game screen based on the result of the process of the game messages and various game data related to the game (e.g., data related to user characters, data representing a virtual space of the game, and data related to various objects to be displayed in the virtual space), and display the generated game screen on the display of the client terminal 30. As with the browser games, a player may provide various inputs to the client terminal 30 based on the game screen, thereby to interact with the game implemented by the server device 10 and the game application programs. The server device 10 can store, for each player, various data such as game messages sent from the game application programs, thereby managing the progress of the game for each player.

Thus, the server device 10 according to a part of the embodiments may manage the web site for providing game services and deliver web pages constituting the web site in response to a request from the client terminal 30, thereby progressing the game. Further, the server device 10 according to a part of the embodiments may process the game messages received from the game application programs executed on the client terminal 30 in place of, or in addition to, those received from the browser game, thereby to progress the online game. Briefly, the server device 10 may also include a function to authenticate a player at start of the game and execute charging process in accordance with progression of the game. The games provided by the server device 10 may include desired games such as action games, role playing games, interactive baseball games, card games, and puzzle games. The types of the games implemented by the server device 10 and the game application programs are not limited to those explicitly described herein. The server device 10 may provide game services to the client terminal 30 in a manner as described above.

The client terminal 30 may be a desired information processing device including at least one of an environment for rendering web pages of a game web site fetched from the server device 10 on a web browser and an application execution environment for executing game application programs. Non-limiting examples of the client terminal 30 may include mobile phones, smartphones, tablet terminals, personal computers, electronic book readers, and game consoles.

As shown, the client terminal 30 may include a processor 31, a main memory 32, a user interface (I/F) 33, a communication I/F 34, and a storage 35, and these components may be electrically connected to one another via a bus 36.

The processor 31 may load various programs such as an operating system into the main memory 32 from the storage 35, and may execute commands included in the loaded programs. The main memory 32 may be used to store a program to be executed by the processor 31, and may be formed of, for example, a dynamic random access memory (DRAM).

The user I/F 33 may include an information input device for receiving inputs from the player and an information output device for outputting an operation result of the processor 31; and the user I/F 33 may include a display device such as a liquid crystal display having a touch panel.

The communication I/F 34 may be implemented as hardware, firmware, or communication software such as a transmission control protocol/Internet protocol (TCP/IP) driver or a point-to-point protocol (PPP) driver, or a combination thereof, and may be configured to be able to communicate with the server device 10 via the network 20.

The storage 35 may comprise, for example, a magnetic disk drive or a flash memory and store various programs such as an operating system. When receiving a game application program from the server device 10 via the communication I/F 34, the storage 35 may store the received game application program.

The client terminal 30 may include, for example, browser software for interpreting an HTML file (HTML data) and rendering a screen; this browser software may enable the terminal device 30 to interpret the HTML data fetched from the server device 10 and render web pages corresponding to the received HTML data. Further, the client terminal 30 may include plug-in software (e.g., Flash Player distributed by Adobe Systems Incorporated) embedded into browser software; therefore, the terminal device 30 can fetch from the server device 10 a SWF file embedded in HTML data and execute the SWF file by using the browser software and the plug-in software. In the client terminal 30, the game application program may be launched in accordance with the operation by the player and executed on a platform implemented on the client terminal 30.

When a game application program is executed on the client terminal 30, for example, animation or an operation icon designated by the program may be displayed on a screen of the client terminal 30. The player may enter an instruction for progressing the game through the user I/F 33 of the client terminal 30.

Next, further detailed description will be made on the functions of the server device 10 and the functions of the game application programs executed on the client terminal 30. The functions of the server device 10 may be implemented by the various modules executed by the processor 11. The functions of the client terminal 30 may be implemented by the various modules executed by the processor 31. In an embodiment of the present invention, the client terminal 30 may fetch a first game application 60 including various instruction sets related to a first game and a second game application program 70 including various instruction sets related to a second game; and these game application programs may be executed by the processor 31. The first game application program 60 may be launched on the client terminal 30 when, e.g., the first game application program 60 is selected by the player from game applications stored on the storage 35.

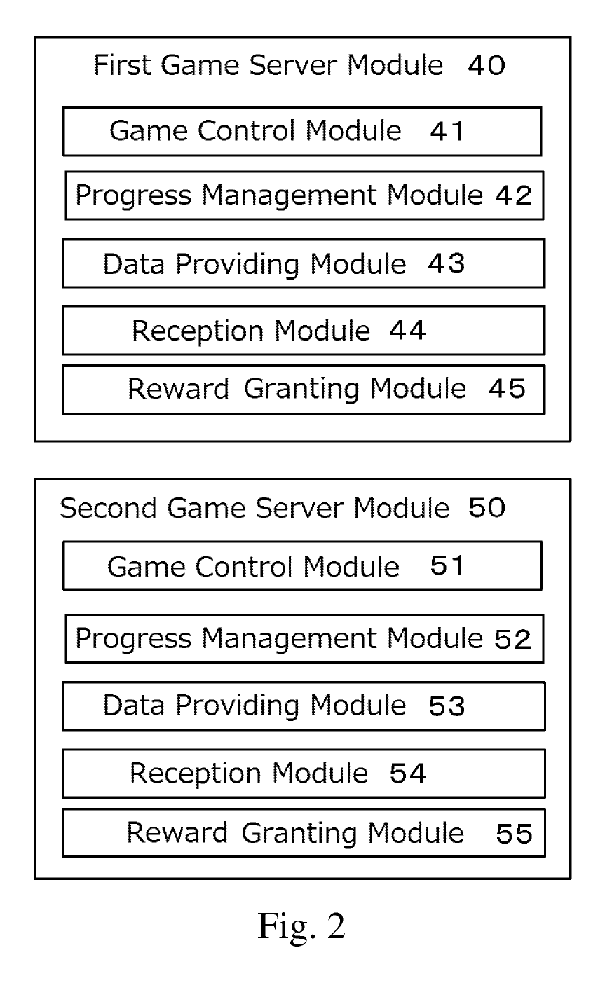

As shown in FIG. 2, a first game server module 40 according to an embodiment may include: a game control module 41 for executing a basic function for progressing the first game in accordance with a predetermined game logic; a progress management module 42 for managing the progress of the first game on the client terminal 30; a data providing module 43 for providing first object generation data to the client terminal 30 in accordance with the progress of the first game; a reception module 44 for receiving a first game switch notification from the client terminal 30; and a reward granting module 45 for granting a reward to a player in accordance with the first game switch notification. Further, a second game server module 50 according to an embodiment may include: a game control module 51 for executing a basic function for progressing the second game; a progress management module 52 for managing the progress of the second game on the client terminal 30; a data providing module 53 for providing second object generation data to the client terminal 30 in accordance with the progress of the second game; a reception module 54 for receiving a second game switch notification from the client terminal 30; and a reward granting module 55 for granting a reward to a player in accordance with the second game switch notification. The first game server module 40 may be a program for providing the first game; and the second game server module 50 may be a program for providing the second game. Since the functions of these modules herein may be mostly common, the following description will be focused on the functions of the first game server module 40. Those skilled in the art could have readily understood the functions of the second game server module 50 based on the description on the functions of the first game server module 40.

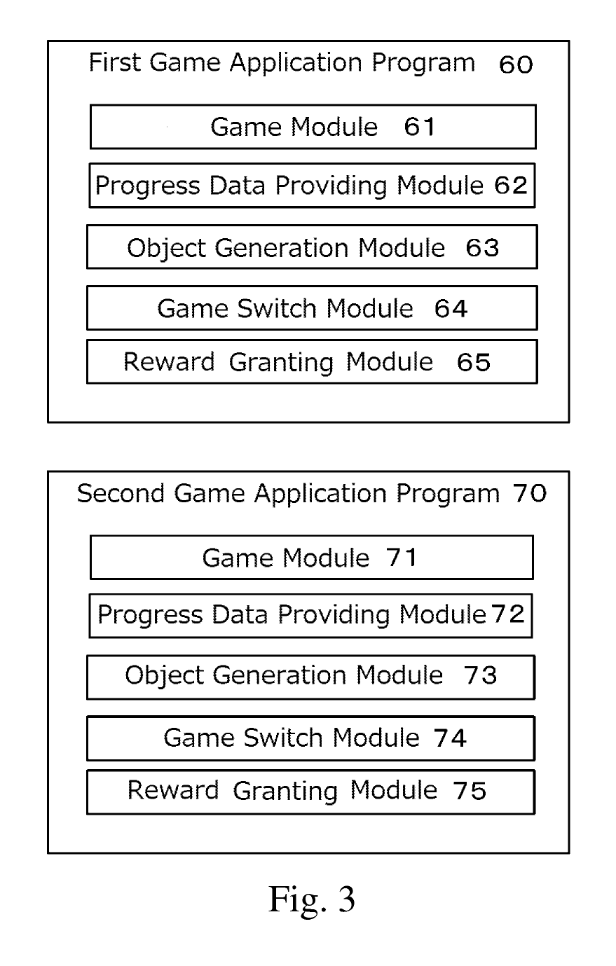

Further, as shown in FIG. 3, the first game application program 60 according to an embodiment may include: a game module 61 for generating an instance of a virtual space of the first game based on the game data related to the first game received from the server device 10; a progress data providing module 62 for sending, to the server device 10, first game progress data indicating the degree to which the first game is progressed; an object generating module 63 for generating the first switch object for making an instruction for switch process to a second game application program 70 based on the first object generation data provided by the server device 10; a game switch module 64 for executing the switch process to the second game application program; and a reward granting module 65 for granting a reward to the player when the switch process to the second game application program is executed. The second game application program 70 according to an embodiment may include: a game module 71 for generating an instance of a virtual space of the second game based on the game data related to the second game received from the server device 10; a progress data providing module 72 for sending, to the server device 10, second game progress data indicating the degree to which the second game is progressed; an object generating module 73 for generating a switch object for making an instruction for switch process to the first game application program 70 based on the second object generation data provided by the server device 10; a game switch module 74 for executing the switch process to the first game application program; and a reward granting module 75 for granting a reward to the player when the switch process to the first game application program is executed. The first game application program 60 may be a client program for providing the first game; and the second game application program 70 may be a program for providing the second game. Since the functions of these programs herein may be mostly common, the following description will be focused on the functions of the first game application program 60. Those skilled in the art could have readily understood the functions of the second game application program 70 based on the description on the functions of the first game application program 60.

In an embodiment, the game control module 41 executed on the server device 10 may provide various game data to the client terminal 30 (e.g., the game module 61 executed on the client terminal 30) so as to provide the first game to the user of the client terminal 30 (the player of the first game). The game data provided by the game control module 41 may include, for example, character data related to a user character, view data for rendering the virtual space of the game in the screen, object data related to various objects to be displayed in the virtual space, and quest data related to a quest experienced by the player. Also, the game control module 41 may provide a chat function and a messaging function to encourage communication between players.

The game module 61 to be executed on the client terminal 30 may be configured to generate a game screen of the first game based on the game data related to the first game received from the server device 10 and display the generated game screen on the display of the client terminal 30. The game data provided by the server device 10 may include various information such as landform information indicating the landform of the virtual space, map information indicating the positions and routes accessible to the player character, object information specifying the types and positions of the objects to be placed in the virtual space, and non-player character information for specifying the types, positions, and movement range of non-player characters. The game module 61 can generate a game screen including a player character, a non-player character, a map, an object, etc. placed therein and present the generated game screen to the player. Thus, the game module 61 may generate a game screen including the images and animation representing the virtual space of the first game based on the game data of the first game provided by the server device 10, and display the game screen on the display of the client terminal 30, thereby to present the instance of the virtual space to the player.

Further, the game module 61 may be configured to send various game messages to the server device 10. The game messages may include various game messages representing, for example, operations on the player character (e.g., instructions for movement and attack on another character) and instructions for use of items.

The progress data providing module 62 according to an embodiment may be configured to send, to the server device 10, the first game progress data indicating the degree to which the first game is progressed by the user of the client terminal 30 (a player of the first game). The first game progress data may include, for example, quest completion data indicating that a particular quest has been completed or indicating the number of completed quests, tutorial completion data indicating that a tutorial has been completed, level data indicating the level of the character of the player, experience point data indicating the experience points obtained by the character of the player, and map position data indicating the position of the character of the player on the map. For example, when the quest completion data indicates that a third quest has been completed, it can be determined based on the quest completion data that the player has progressed the game to the completion of the third quest.

The first game progress data from the progress data providing module 62 may be received by the server device 10 via the communication I/F 14 and then provided to the progress management module 42. The progress management module 42 may be configured to manage the progress of the first game for each player based on the first game progress data from the progress data providing module 62. For example, the progress management module 42 may store, in a management table not shown, the completion of a particular quest or tutorial and the completion of a particular number of quests in the first game, the level of the character, and the position of the character on a map for a player playing the first game by using the first game application program 60, in association with the ID of the player, based on the first game progress data received from the first game application program 60. The above management table may be stored on, e.g., a database server (not shown) communicatively connected to the server device 10. The management table may also be stored on the storage 15.

In an embodiment, the data providing module 43 may be configured to determine the progress status of the first game by the player based on the first game progress data and provide the first object generation data to the client terminal 30 (the first game application program 60) of the player in accordance with the determined progress status. As will be stated later, the first object generation data may be used to generate the first switch object for instruction for start of the switch process to the second game application program 70 on the client terminal 30.

The data providing module 43 may determine whether a particular player has progressed beyond a particular milestone in the first game by, e.g., comparing the first game progress data with a particular threshold value. For example, this threshold value may indicate the level of the character of the player. For example, when the level indicated by the game progress data is higher than the level specified by the threshold value (e.g., “level 20”), the data providing module 43 may determine that the player has progressed the first game enough, and provide the first object generation data to the client terminal 30.

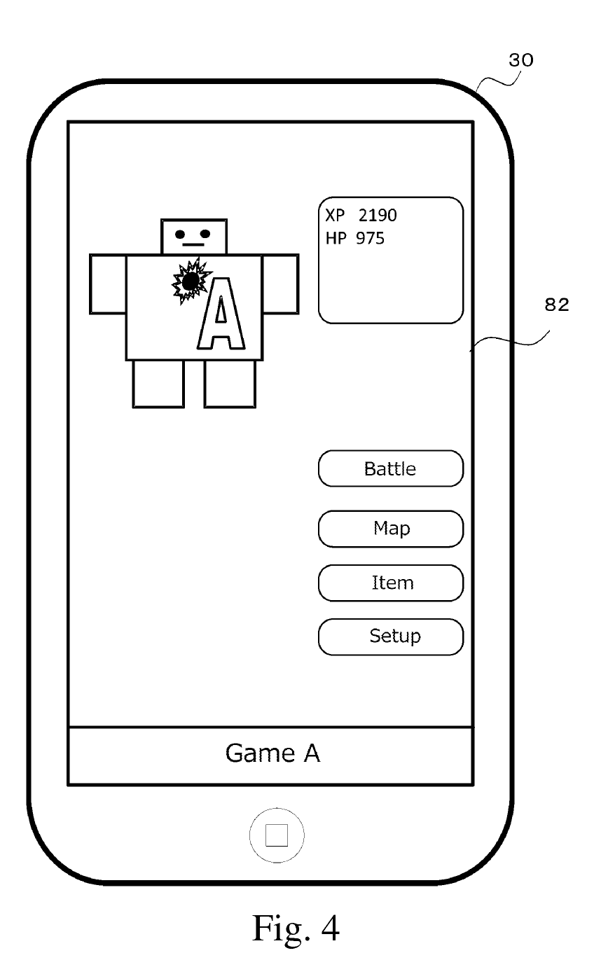

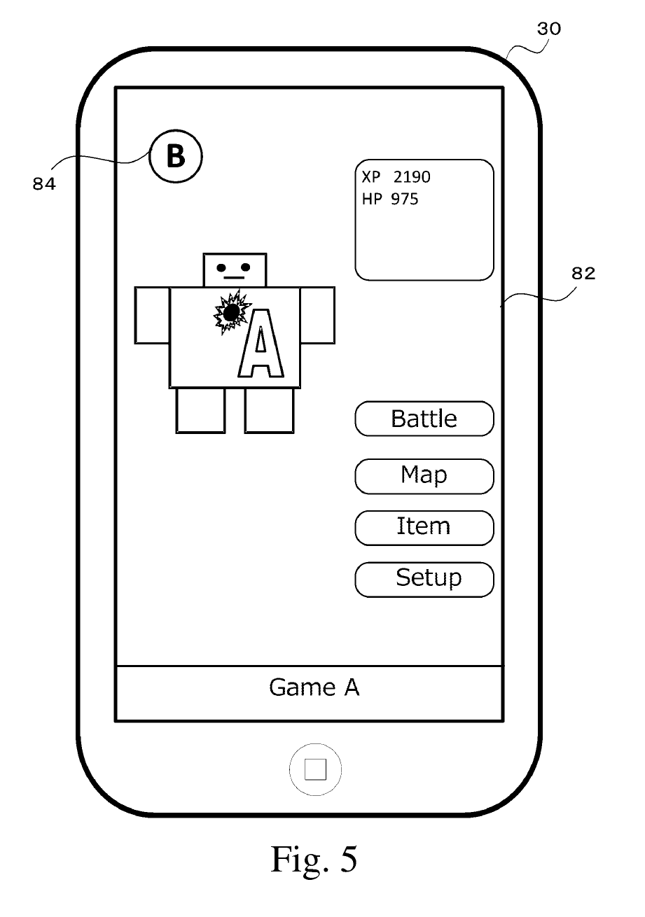

The first object generation data may be received by the client terminal 30 via the communication I/F 34. The received first object generation data may be provided to the object generation module 63. The object generation module 63 may be configured to generate the first switch object for instruction for the switch process to the second game application program 70 based on the obtained first object generation data, and provide the generated first switch object to the player. For example, when the first object generation data is received while the game screen 82 of the first game (“game A”) shown in FIG. 4, the object generation module 63 may generate the first switch object 84 shown in FIG. 5 based on the first object generation data and superpose the generated first switch object 84 on the game screen 82.

When the player selects the first switch object 84 via the user I/F 33, the game switch module 64 may start the switch process to the second game application program associated with the first switch object 84. If, e.g., the second game application program is not stored on the client terminal 30, the game switch module 64 may download the second game application program from the storage 15 or storage 25 in response to the selection of the first switch object 84. More specifically, the game switch module 64 may display, on the game screen, a download screen for encouraging the user to download the second game application program 70 and download the second game application program 70 in accordance with an instruction from the user.

If the second game application program is stored on the client terminal 30 at the timing when the first switch object 84 is selected, the game switch module 64 may execute a process for launching the second game application program. For example, the game switch module 64 may provide a launch command for launching the second game application program 80 to a launch module (not shown and executable on the processor 31) for launching the second game application program 80, and the launch module may provide the second game application program.

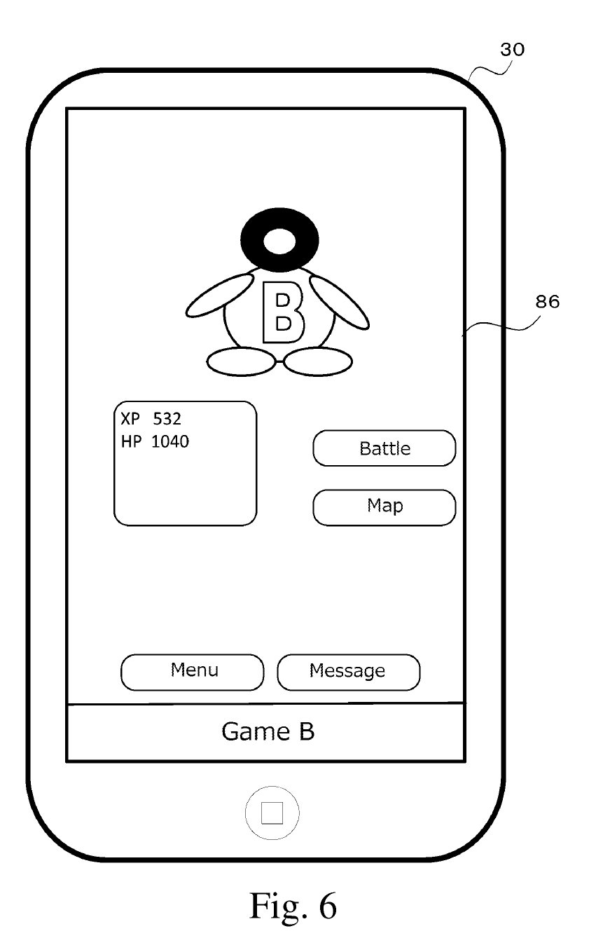

If the second game application program 70 has already been launched (but is not active) on the client terminal 30 at the timing when the first switch object 84 is selected, the game switch module 64 may activate the second game application program. When the second game application program is activated, the game screen 86 of the second game (“game B”) may be displayed on the display of the client terminal 30, as shown in FIG. 6. The player can interact with players of the second game via the game screen 86. When the second game application program 70 is activated, the operation input by the player may be provided to the modules constituting the second game application program 70.

Thus, the switch process to the second game application program may include any one of the process of activating the second game application program 70, the process of launching the second game application program 70, and the process of starting download of the second game application program 70; the game switch module 64 may execute one of these processes in accordance with whether the second game application program 70 has been launched on the client terminal 30 and whether the second game application program 70 is stored on the client terminal 30 at the timing when the switch object 84 is selected.

The first switch object 84 may be displayed on the game screen 82 of the first game in various modes. In the example shown in FIG. 5, the switch object 84 may be displayed on the home screen 82 (the game screen displayed immediately after the first game application program 60 for executing the first game is launched) of the first game. When the first game transitions from the home screen 82 to another game screen (e.g., a map display screen), the first switch object 84 may either disappear from the game screen or remain in the game screen after the transition. As shown in FIG. 5, the first switch object 84 may be displayed at a relatively noticeable position in the upper portion of the game screen (e.g., the upper portion of the game screen).

In an embodiment of the present invention, the game switch module 64 may be configured to send to the server device 10 a first game switch notification indicating that the switch process to the second game has been executed after or in parallel with the switch process to the second game. The reception module 44 executed on the server device 10 may be configured to receive the game switch notification from the client terminal 40 (the first game application program 60).

When the reception module 44 receives the first game switch notification, the reward granting module 45 may grant a reward (first reward) to the player of the first game. The rewards provided to the player may include various rewards usable inside and outside the games. For example, the rewards granted to the player may include at least one of: in-game rewards usable in the first game before the transition (e.g., experience points of the player character of the first game, virtual currency usable in the first game, items usable in the first game), in-game rewards usable in the second game after the transition (e.g., experience points of the player character of the second game, virtual currency usable in the second game, items usable in the second game), virtual currency commonly usable in both the first game and the second game, and ex-game virtual items usable outside the game.

In an embodiment of the present invention, a reward may be granted to the player by the reward granting module 65 provided to the first game application program 60 in addition to, or in place of, the reward granting module 45. When the game switch module 64 executes the switch process to the second game, the reward granting module 65 may grant a reward to the player. The reward granting module 65 may communicate the reward data indicating the reward granted to the player to the server device 10. The server device 10 may update the experience points of the character of the player, the virtual currency owned by the player, etc. based on the communicated reward data.

In the above embodiment, the player may select the first switch object 84 displayed in the game screen 82 of the first game being played, thereby to readily switch to the second game application program 70; and on this switch, a reward may be granted to the player. Therefore, the player may be motivated to select the first switch object 84 to switch to the second game application program 70 (download, launch, or activate the second game application program 70). Further, the first switch object 84 may be generated based on the first object generation data provided to the client terminal 30 in accordance with the progress of the first game; therefore, the player may be guided to the second game at a desired timing determined in accordance with the progress of the game. For example, after the player has progressed the first game enough (e.g., after half or more of all the quests have been completed, after ten or more quests have been completed, after the level has reached or exceeded 30, after the obtained experience points reached or exceeded 10,000 points, or after the character has advanced to a particular point on the map), the first object generation data may be generated, such that the first switch object 84 can be presented to the player after the player has been devoted to the first game enough. The conditions for generating the first object generation data may be adjusted so as to present the first switch object 84 to the player at a desired timing in accordance with the progress of the first game.

Further, when the player selects the first switch object 84 to switch to the second game application program 70, an in-game reward usable in the first game before transition may be provided, such that the player who has once moved to the second game may be encouraged to return to the first game.

The reward granting module 45 may have an upper limit for granting a reward. For example, if the amount of rewards granted to a particular player within a particular period exceeds a predetermined upper limit, the reward granting module 45 may suspend granting of rewards until the particular period elapses, even in the case where the player selects the first switch object 84 to switch to the second game application program 70. In this case, the reward granting module 45 may resume granting of rewards after the particular period has elapsed. For example, a reward may be granted to the player when the player selects the first switch object 84 to switch to the second game application program 70 after the particular period has elapsed. Likewise, the reward granting module 65 may also have an upper limit for granting rewards.

Next to be described is the functions executed on the server device 10 and the client terminal 30 when the second application program 70 is activated on the client terminal 30. The second game application program 70 may be executed by the processor 31 of the client terminal 30, as may be the first game application program. When the second game application program is executed on the client terminal 30, the user of the client terminal 30 can play the second game (“game B”) different from the first game (“game A”).

The game module 71 of the second game application program 70 can execute an instance of the virtual space of the second game based on the game data related to the second game received from the second server module 50 (e.g., the game control module 51) of the server device 10. The progress data providing module 72 may send the second game progress data indicating the degree to which the player has progressed the second game.

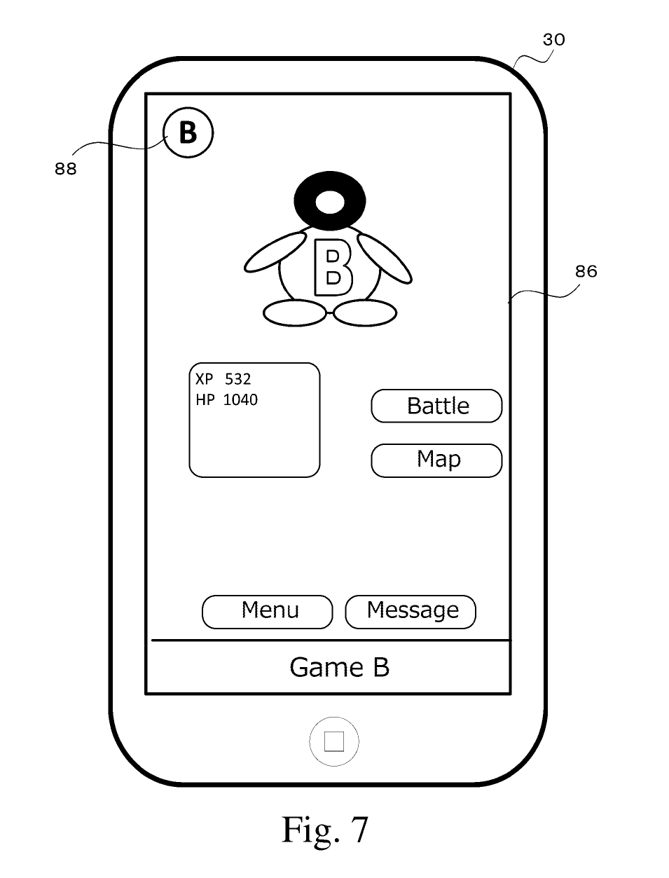

The progress management module 52 of the server device 10 can manage the progress of the second game based on the second game progress data from the progress data providing module 72. The data providing module 53 may determine the progress status of the second game based on the second game progress data and provide the second object generation data to the client terminal 30 (the second game application program 70) in accordance with the determined progress status. The second object generation data may be used to generate the second switch object (e.g., a second switch object 88 shown in FIG. 7) for instruction for start of the switch process to the first game application program 60 on the client terminal 30.

The object generation module 73, which has obtained the second object generation data from the server device 10, may generate the second switch object based on the obtained second object generation data and present the generated second switch object to the player. As shown in FIG. 7, the object generation module 73 may generate the second switch object 88 based on the second object generation data and superpose the generated second switch object 88 on the game screen 86 of the second game on the display of the client terminal 30. When the player selects the second switch object 88, the game switch module 74 may execute the switch process to the first game application program 60 associated with the second switch object 88. When the game switch module 74 executes the switch process to the first game application program 60, the reward granting module 75 may grant a reward (second reward) to the player. It may also be possible that the reception module 54 of the server device 10 should receive the second game switch notification from the client terminal 30 (the second game application program 70), and the reward granting module 55 should grant a reward to the player of the second game when the second game switch notification is received.

In the embodiment described above, the second switch object 88 for instruction for the switch process to the first game application program 60 may be displayed in the second game provided by the second game application program 70 (and the second game server module 50) after the game is switched from the first game application program 60 to the second game application program 70 and the second game application program 70 is activated. The player has only to select the second switch object 88 to readily return to the first game application program 60 (the first game played before the transition to the second game).

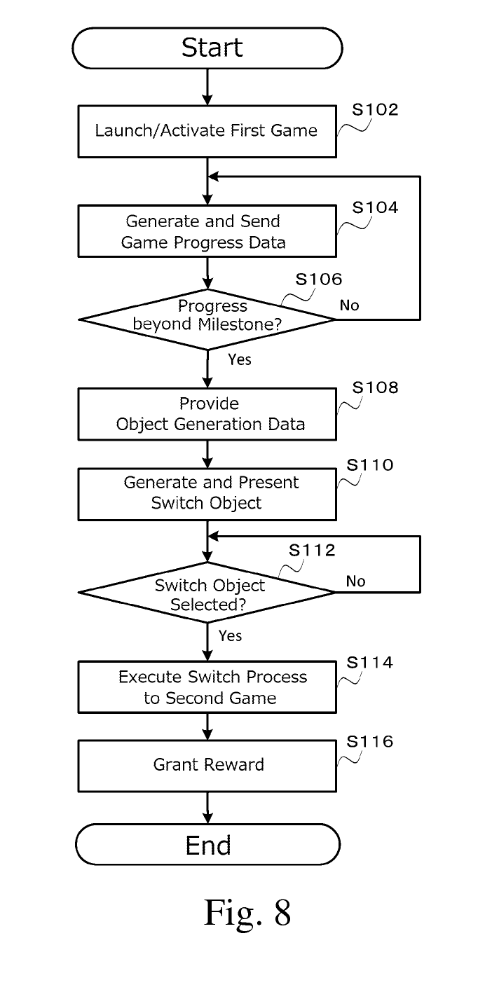

Next, the process flow in an embodiment of the present invention will be described with reference to FIG. 8. FIG. 8 is a flow diagram showing an example of process flow from the start of the first game (activation of the first game application program) to the switch to the second game (activation of the second game application program).

First, in step S102, the first game application program for executing the first game may be launched and activated on the client terminal 30. The first game application program may be, for example, the first game application program 60 in the above embodiment. When the first game application program is activated, for example, a home screen 82 as shown in FIG. 4 may be displayed on the client terminal 30. The home screen 82 may contain objects associated with instructions to be given to the game; and the player may select the object via the user I/F 33 thereby to operate the first game desirably. In an embodiment, the game module 61 may execute the process of displaying the home screen 82 of the first game and the processes corresponding to the instructions from the player.

Next, in step S104, the game progress data indicating the degree to which the first game is progressed may be generated and sent to the server device 10. In an embodiment, the first game progress data may be generated and sent to the server device 10 by the progress data providing module 62. The first game progress data sent from the client terminal 30 may be received by the server device 10 and managed by, e.g., the progress management module 42 for each player.

Next, in step S106, the degree to which the first game has been progressed by the user of the client terminal 30 may be determined based on the first game progress data from the client terminal 30. In an embodiment, it may be determined whether the first game has been progressed beyond a predetermine milestone by the user based on the first game progress data. Examples of the milestone may be, for example, that more than a predetermined number of quests have been completed, that a tutorial has been completed, and that the level has reached a predetermined level. If it is determined that the user has not yet reached the milestone in the first game, the process may return to step S104 where the server device 10 may resume reception of the first game progress data.

If it is determined in step S106 that the first game has been progressed enough (e.g., it has been progressed to a predetermined milestone), the processing may proceed to step S108. In step S108, the first object generation data may be generated and provided to the client terminal 30. It may also be possible that the server device 10 should previously generate and store the first object data and, when it determines that the first game has been progressed enough by the user, the server device 10 should read out the first object data and provide that to the client terminal 30. In an embodiment, the data providing module 43 may determine whether the first game has been progressed enough by the user and provide the first object generation data based on the determination.

Next, in step S110, the first switch object for instruction for the switch process to the second game application may be generated on the client terminal 30 based on the first object generation data provided from the server device 10. An example of the first switch object generated in step S110 may be the switch object 84 shown in FIG. 5. As shown in FIG. 5, the generated first switch object may be presented to the player by, e.g., display in the game screen. In an embodiment, the object generation module 63 may generate the first switch object and present it to the player in step S110.

Next, when it is detected in step S112 that the player has selected the first switch object, the processing may proceed to step S114 where the server device 10 may execute the switch process to the second game application program associated with the first switch object. For example, the client terminal 30 may include a touch screen; and when the player touches (e.g., taps) a position corresponding to the first switch object on this touch screen, the selection of the first switch object may be detected. When the selection of the first switch object is detected, the processing may proceed to step S114 where the server device 10 may execute the switch process to the second game application program associated with the selected first switch object. For example, the game switch module 64 may detect the selection of the first switch object and execute the switch process to the second game application program.

After the switch process to the second game application program, the processing may proceed to step S116. In step S116, a predetermined reward is granted to the player. This process of granting a reward may be executed by the reward granting module 45 or the reward granting module 65. When the reward is granted to the player, the processing in this embodiment may be ended.

When the switch process to the second game application is executed in step S114 to activate the second game application program, the steps S102 to S116 may be executed for the second game application program. In this case, the second object data may be generated (step S108) in accordance with the progress status of the second game executed by the second game application program (step S106). When the player selects the second switch object (step S112) generated based on the second object data (step S110), the switch process to the first game application program may be executed (step S114) and a reward may be provided to the player (step S116). When the first game application program is activated in this switch process, the first game may have already been progressed beyond a predetermined milestone; therefore, the game screen of the first game may always be generated by the first switch object.

The modules in FIG. 1, which were described to be executed on the server device 10, may also be executed by processors provided outside the server device 10 (e.g., the processor 31 of the client terminal 30) or processors of other devices. Also, the modules in FIG. 1, which were described to be executed on the client terminal 30, may also be executed by the processor 11 of the server device 10 or processors of other devices.

Even if the processes and the procedures described herein are executed by a single apparatus, software piece, component, or module, such processes and procedures may also be executed by a plurality of apparatuses, software pieces, components, and/or modules. Even if the data, tables, or databases described herein are stored in a single memory, such data, tables, or databases may also be dispersed and stored in a plurality of memories included in a single apparatus or in a plurality of memories dispersed and arranged in a plurality of apparatuses. The elements of the software and the hardware described herein can be integrated into fewer constituent elements or can be decomposed into more constituent elements.

With respect to the use of substantially any plural and/or singular terms herein, those having skill in the art can translate from the plural to the singular and/or from the singular to the plural as is appropriate to the context.

The procedures described herein, particularly those described with a flowchart, are susceptible of omission of part of the steps constituting the procedure, adding steps not explicitly included in the steps constituting the procedure, and/or reordering the steps. The procedure subjected to such omission, addition, or reordering is also included in the scope of the present invention unless diverged from the purport of the present invention.

### LIST OF REFERENCE NUMBERS

| | |
|---|---|
| 10 | server device |
| 11, 31 | processor |
| 15, 25, 35 | storage |
| 30 | client terminal |
| 40 | first game server module |
| 50 | second game server module |
| 60 | first game application program |
| 70 | second game application program |
| 41, 51 | progress management module |
| 42, 52 | data providing module |
| 43, 53 | reception module |
| 44, 54 | reward granting module |
| 61, 71 | game module |
| 62, 72 | progress data providing module |
| 63, 73 | object generation module |
| 64, 74 | game switch module |
| 65, 75 | reward granting module |

1. A server device for providing game services to a client terminal communicatively connected to the server device, the server device comprising:
one or more processors configured to execute a computer program, wherein the computer program comprises:
a progress management module configured to manage progress of a first game based on first game progress data related to progress of the first game by a player, the first game progress data being provided by the client terminal executing a first game application program;
a data providing module configured to provide the client terminal with first object generation data for generating first object, in accordance with progress of the first game;
a reception module configured to receive a first game switch notification from the client terminal if the first object is selected in the first game to start a switch process to a second game application program on the client terminal; and
a reward granting module configured to grant a first reward to the player in response to the first game switch notification; and, wherein
the progress management module is configured to manage progress of a second game based on second game progress data related to progress of the second game, the second game progress data being provided by the client terminal executing the second game application program;
the data providing module is configured to provide the client terminal with second object generation data for generating a second object, in accordance with progress of the second game;
the reception module is configured to receive a second game switch notification from the client terminal if the second object is selected in the second game to start a switch process to the first game application program on the client terminal; and
the reward granting module is configured to grant a second reward to the player in response to the second game switch notification.

2. (canceled)

3. The server device of claim 1 wherein the first reward is at least one of a first in-game reward usable in the first game and a second in-game reward usable in the second game.

4. The server device of claim 1 wherein the second reward is at least one of a first in-game reward usable in the first game and a second in-game reward usable in the second game.

5. The server device of claim 1 wherein, when the first reward granted to the player in a first period exceeds a first upper limit, the reward granting module suspends granting of the first reward to the player until the first period elapses.

6. The server device of claim 1 wherein, when the second reward granted to the player in a second period exceeds a second upper limit, the reward granting module suspends granting of the second reward to the player until the second period elapses.

7. The server device of claim 1 wherein the switch process to the second game application program is any one of a process for activating the second game application program, a process for launching the second game application program, and a process for downloading the second game application program.

8. A game application program for causing a client terminal communicatively connected to a server device to execute a first game, the game application program comprising:
a progress data providing module configured to provide the server device with game progress data indicating progress of the first game;
an object generation module configured to generate a first object based on first object generation data provided by the server device in accordance with progress of the first game indicated by the game progress data;
an object presenting module configured to present the first object to a player of the first game;
a game switch module configured to execute a switch process to another application program for causing the client terminal to execute a second game, in response to a selecting operation on the first object; and
a reward granting module configured to grant a reward to the player when the switch process is executed,
wherein, when the reward granted to the player in a predetermined period exceeds a predetermined upper limit, the reward granting module suspends granting of the reward to the player until the predetermined period elapses.

9. The game application program of claim 8 wherein the reward is at least one of a first in-game reward usable in the first game and a second in-game reward usable in the second game.

10. (canceled)

11. The game application program of claim 8 wherein the switch process to the other game application program is any one of a process for activating the other game application program, a process for launching the other game application program, and a process for downloading the other game application program.
